(19) United States
(12) Patent Application Publication
(10) Pub. No.: US 2019/0220825 A1
(43) Pub. Date: Jul. 18, 2019

(54) System and Method of Tracking Sales Calls

(71) Applicant: Ashraf Rasoul, Memphis, TN (US)

(72) Inventor: Ashraf Rasoul, Memphis, TN (US)

(21) Appl. No.: 16/246,492

(22) Filed: Jan. 12, 2019

Related U.S. Application Data
(60) Provisional application No. 62/616,840, filed on Jan. 12, 2018.

(51) Int. Cl. G06Q 10/10; G06Q 10/06; G06Q 30/00; G06Q 30/02; H04W 4/021; H04W 4/33

(52) U.S. Cl. CPC G06Q 10/1091; G06Q 10/0639; H04W 4/33; G06Q 30/0201; H04W 4/021; G06Q 30/01

(57) ABSTRACT

A system for a sales organization to verify, track and report activities of sale persons at customers' locations during sales calls and to generate reports therefrom. The system includes a customer relationship management (CRM) program; a plurality of mobile devices, each mobile device having an application program configured for two-way communication with the CRM program, each mobile device associated with one of the sales persons; a plurality of beacon emitters, each beacon emitter located at a customer location and associated with the one of the customers; each of the mobile devices configured via the application program to functionally communicate with the beacon emitters only when the mobile device is placed within a functional distance in proximity to one of the beacon emitters. The CRM program is configured to administer a plurality of sales call events between the sales persons and the customers. Methods of using the systems are provided.

### CROSS REFERENCE TO RELATED APPLICATIONS

This application claims the benefit of U.S. Provisional Patent Application 62/616,840 filed Jan. 12, 2018, which is pending.

The foregoing applications and patents are incorporated herein by reference in their entireties.

### STATEMENT REGARDING FEDERALLY SPONSORED RESEARCH

Not applicable

### FIELD OF THE INVENTION

The present invention relates to sales calls and, more particularly, to a system and method of tracking sales calls.

### BACKGROUND OF THE INVENTION

Sales organizations and customers do not have the ability precisely verify, track and report how much time sales people spend at individual accounts. In addition, customer relationship management (CRM) programs are usually one sided and do not represent a two-way form of communication between customer and sales person.

Current methods rely on GPS location services to track general area of a sales person. GPS locators can only verify a general area of location and are unable to distinguish various locations and customer acceptance. This is problematic in such situations as a high-rise office building.

Currently available CRM systems include web-hosted systems such as SAP's salesforce.com system.

In wireless networks, a beacon is a type of frame which is sent by the access point (e.g. WiFi router) to indicate that it is on. Bluetooth based beacons periodically send out a data packet that is used by software to identify the beacon location. Beacon emitters are typically used by indoor navigation and positioning applications.

The use of beacons in combination with personal devices can be used to track numerous personal interactions such as time spent by a consumer at a department store or amount of time a consumer spends using a fee-for-time product or service. By producing various software platforms to register beacon devices with personal devices any time sensitive business or personal activities can be accurately verified and recorded.

Although beacon emitters have been used to track customers in retail locations, there has been no attempt to use beacon emitters to verify and track the efficiency of sales people in conjunction with CRM systems. As can be seen, there is a need for an improved system and method of tracking sales calls.

### OBJECTS AND SUMMARY OF THE INVENTION

It is an object of the inventions to provide improved systems and methods of tracking sales calls.

It is another object of the inventions to provide a two-way communication system using beacon technology for verifying the location and efficiency of sales persons during sales calls to customers.

Yet another object of the inventions is to provide reports analyzing the location and efficiency of sales persons using data gathered by the systems and methods of tracking sales calls.

The foregoing objectives are achieved by providing systems and methods for verifying, tracking and reporting having the features described herein.

A system and method of utilizing beacons and personal devices in conjunction with a CRM software system as described herein and illustrated in the drawings.

A system for a sales organization to verify, track and report activities of sale persons at customers' locations during sales calls and to generate reports therefrom, the system comprising a customer relationship management program hosted on a remote server; a plurality of mobile devices, each of the mobile devices having an application program configured for two-way communication with the customer relationship management program via the remote server, each mobile device associated with one of said sales persons; a plurality of beacon emitters, each of the beacon emitters located at one of said customers' locations and associated with said one of said customers; each of the mobile devices configured via the application program to functionally communicate with the beacon emitters only when the mobile device is placed within a functional distance in proximity to one of the beacon emitters.

The customer relationship management program is configured to administer a plurality of sales call events between said sales persons and said customers. Administration of each of the sales call events comprises: an initiating one of said sales persons requesting a sales call appointment with a selected one of said customers; said selected customer accepting the sales call appointment with said initiating sales person; recording a start time of the sales call event when said initiating sales person places said initiating sales person's mobile device within the functional distance of the selected customer's beacon emitter at the beginning of the sales call event; recording a finish time of the sales call event when said initiating sales person places said initiating sales person's mobile device within the functional distance of the selected customer's beacon emitter at the conclusion of the sales call event; and calculating the duration of the sales call event based on the start time and the finish time of the sales call event.

The customer relationship management program is configured to selectively generate reports using data recorded by the system during administration of the plurality of sales call events.

In embodiments, the functional distance in proximity to the beacon emitter is between zero to about six inches. In embodiments, the functional distance in proximity to the beacon emitter is between zero to about one inch.

The remote server can be a cloud server. The beacon emitters can be provided to said customers by a host of the customer relationship management program. The beacon emitters can be provided to said customers at no charge to said customers, or to the sales organization.

The customer relationship management program can be configured to allow the customers to selectively generate and review reports about said customers' respective sales persons. The customer relationship management program can be further configured to receive and record input information about the plurality of sales call events. The input information can include information input into the system by said sales persons, such as during or after a sales call. The input information can include information input into the system by said customers, such as during or after a sales call. The selectively generated reports can include input information.

The beacon emitter can be a micro-beacon. The system works in conditions where GPS tracking is not accurate, such as when the customer's location is a high-rise building.

Methods of using the system are also disclosed.

The foregoing and other objects, features, aspects and advantages of the invention will become more apparent from the following detailed description of the invention when considered in conjunction with the accompanying drawings.

### BRIEF DESCRIPTION OF THE DRAWINGS

FIG. 1A-1B is a schematic flow of one embodiment of the customer relationship management system of the present invention.

FIG. 2 is a schematic representation of one embodiment of the customer relationship management system of the present invention.

### PREFERRED EMBODIMENTS OF THE INVENTION

In the following detailed description of the preferred embodiments, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

The present invention includes a business service 1 that uses beacon proximity technology 200 in conjunction with CRM software 102. The present invention uses a beacon 200 and micro beacon technology 200 in personal mobile devices 10, such as phones and tablets, to verify location at each specific sales call point 140 and the amount of time spent at each sales call point. The present invention communicates with the CRM program 102 in a 2-way method allowing for both the sales person 122 and the customer 140 to communicate with one another for various reporting needs. Operation of the system 1 via the conventional cloud 90 is envisioned as being most efficient, although cloudless operations could be configured.

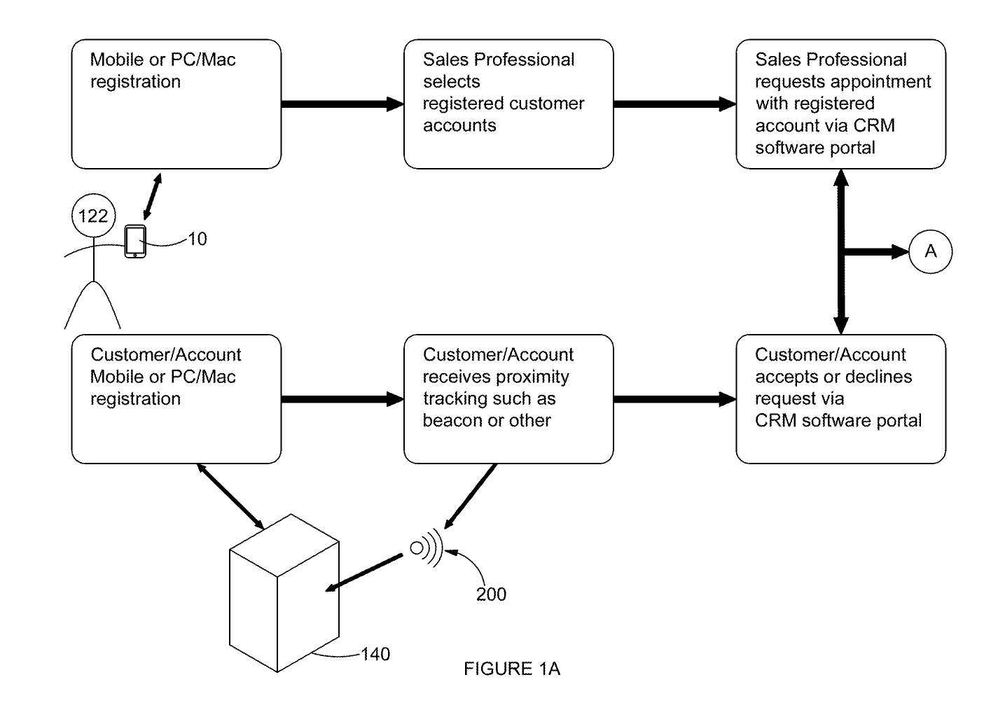

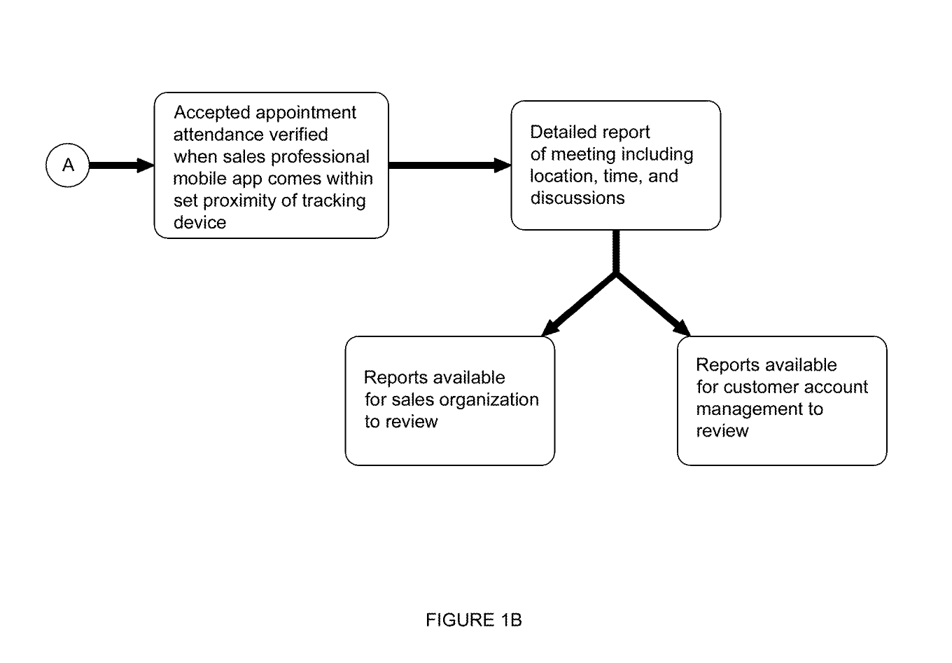

Referring now to FIGS. 1A-1B, the present invention may include the following steps:

1. Customer 140 agrees to having a beacon 200 physically placed onsite of location where sales calls are made.

2. Customer 140 agrees to using CRM software 102 that will list the customer 140 as having a beacon.

3. Sales representative 122 or sales organization 120 download CRM software 102 to personal devices 10 that list customer 140s with beacons 200.

4. Sales people 122 requests an appointment or makes a cold call to customer 140 with a beacon 200 and place their personal device 10 within a selected functional distance (e.g. an inch) of beacon 200 using BLUETOOTH® technology to register with the customer 140's beacon 200.

5. When leaving the sales call, the sales person 122 once again places their personal device near the customer's 140 beacon 200 to register the end of their sales call.

6. The customer 140 can use reports from the CRM software to review the amount of time spent with sales people for efficiency, accountability, and follow up purposes.

7. Sales people and organizations can use reports from the CRM software to review sales call accuracy, accountability and follow up.

Steps 1-3, shown generally in FIG. 1A, establish a relationship of accepted or cleared sales calls by having the customer 140s list their availability on the CRM software 102 and having the sales person 122 request an appointment. Steps 4-7, shown generally in FIG. 1B, ensure the sales call was actually made by registering via the customer 140's beacon the arrival and departure of the sales representative 122 with their personal device via BLUETOOTH®. The CRM software 102 allows for notes from both the customer 140 and sales person 122 for reporting reasons.

By following the above listed steps, both the customer 140 and sales person 122 or sales organization 120 can verify the exact location and amount of time spent on a sales call as well as identify whether it was an approved sales call or not. By following the steps above, sales people 122 register their personal device 10 with the location beacon 200 at each sales call, and both the customer 140 and sales person 122 or sales organization 120 are able to accurately confirm an actual sales call was made and how much time was spent on that sales call, making sales calls more accountable.

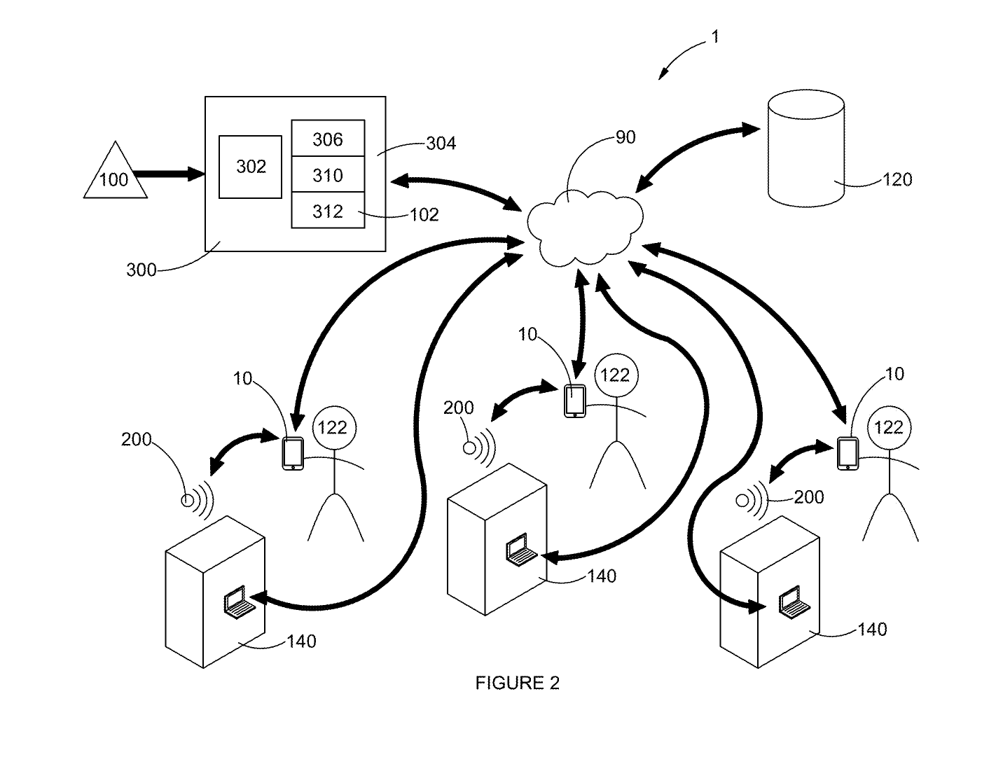

FIG. 2 is a schematic diagram of an embodiment of the system 1. The system 1 includes a computing device 300 implementing a customer relationship management program 102. The computing device 300 can be any type of computing device, and can be composed of multiple computing devices. The computing device 300 can include a conventional central processing unit (CPU) 302 or a plurality of CPUs capable of manipulating or processing information. A memory 304 in the computing device 300 can be a random access memory device (RAM) or any other suitable type of storage device. The memory 304 can include data 306 that is accessed by the CPU 302 such as via a bus. The memory 304 can include an operating system 310 and installed applications 312. The installed applications 312 include the customer relationship management program 102 that permits the CPU 302 to perform the customer relationship management methods and operations described herein. The computing device 300 can be associated with a database server, such as a cloud database server, for secure storage and retrieval of large amounts of data. The computing device 300 can also include additional or secondary storage, for example, a memory card, flash drive, or any other form of computer readable medium.

The customer relationship management system 1 is provided by a service provider 100. The service provider 100 may maintain and operate the CRM software 102 on external cloud-based servers and associated database servers. For example, the computing device 300 can be a cloud computing service and operate over the cloud 90.

FIG. 2 shows a schematic view of one embodiment of a sales organization, sales persons 122 and customers 140 communication interface to the customer relationship management system of FIG. 1. The system includes a beacon emitter 200 physically located at each of a plurality of customers' locations 140. The mobile devices 10 of the individual sales persons 122 communicate with the beacon emitters when placed a functional distance from a beacon emitter 200, thus verifying the start and end of a sales call event, as described herein. The mobile device 10 can be any device convenient for portable communication, which currently includes smartphones, tablets, PDAs, laptops (PC, Mac), and the like. The mobile device 10 can be configured, through the use of a specific application, or “app,” to recognize the information broadcast by the beacon device 200, and in turn, send information to and/or request/receive information from the computing device 300 of FIG. 1.

The system of the invention improves upon existing CRM systems by providing a two-way communication between the customer 140, the sales person 122 and incorporating a precise location verification function.

While various forms of emitters could be used, the current state of the art is a standard commercially available beacon device 200 that emits a signal, such as via a blue-tooth connection. The sales organization 120 programs the beacon emitter and leaves it at the customer 140's location. The situation is analogous to giving the lock away (the beacon 200) and keeping the key (the sales program 1).

The system 1 is configured such that the CRM application and the beacon 200 have to be near each other in order to prevent false positives.

The sales organization 120 benefits by having better control of time and data about its sales persons 122. Customers 140 benefit from better oversight of sales persons 122 as well as the opportunity to provide feedback to the system 1, such as reviews of the sales person 122. Individual sales representatives 122 benefit by having accurate data for performance assessment or improvement of efficiency.

Users of the system, such as sales organizations 120 or individual sales persons 122, pay a fee to use the system. For example, the sales representative may pay a periodic fee, such as a monthly fee. Alternatively, the sales representative may pay a per use fee.

Although the present invention has been described in terms of specific embodiments, it is anticipated that alterations and modifications thereof will no doubt become apparent to those skilled in the art. It is therefore intended that the following claims be interpreted as covering all alterations and modifications that fall within the true spirit and scope of the invention.

What is claimed is:

1. A system for a sales organization to verify, track and report activities of sale persons at customers' locations during sales calls and to generate reports therefrom, the system comprising:
a customer relationship management program hosted on a remote server;
a plurality of mobile devices, each of the mobile devices having an application program configured for two-way communication with the customer relationship management program via the remote server, each mobile device associated with one of said sales persons;
a plurality of beacon emitters, each of the beacon emitters located at one of said customers' locations and associated with said one of said customers;
each of the mobile devices configured via the application program to functionally communicate with the beacon emitters only when the mobile device is placed within a functional distance in proximity to one of the beacon emitters;
the customer relationship management program configured to administer a plurality of sales call events between said sales persons and said customers, administration of each of the sales call events comprising:
an initiating one of said sales persons requesting a sales call appointment with a selected one of said customers;
said selected customer accepting the sales call appointment with said initiating sales person;
recording a start time of the sales call event when said initiating sales person places said initiating sales person's mobile device within the functional distance of the selected customer's beacon emitter at the beginning of the sales call event;
recording a finish time of the sales call event when said initiating sales person places said initiating sales person's mobile device within the functional distance of the selected customer's beacon emitter at the conclusion of the sales call event; and
calculating the duration of the sales call event based on the start time and the finish time of the sales call event;
the customer relationship management program configured to selectively generate reports using data recorded by the system during administration of the plurality of sales call events.

2. The system of claim 1, wherein the functional distance in proximity to the beacon emitter is between zero to about six inches.

3. The system of claim 1, wherein the functional distance in proximity to the beacon emitter is between zero to about one inch.

4. The system of claim 1, wherein the remote server is a cloud server.

5. The system of claim 1, wherein said beacon emitters are provided to said customers by a host of the customer relationship management program.

6. The system of claim 1, wherein said beacon emitters are provided to said customers at no charge to said customers.

7. The system of claim 1, wherein said beacon emitters are provided to said customers at no charge to said sales organization.

8. The system of claim 1, the customer relationship management program further configured to allow said customers to selectively generate and review reports about said customers' respective sales persons.

9. The system of claim 1, the customer relationship management program further configured to receive and record input information about the plurality of sales call events.

10. The system of claim 9, wherein the input information includes information input into the system by said sales persons.

11. The system of claim 10, wherein the input information includes information input into the system by said customers.

12. The system of claim 11, wherein the selectively generated reports include input information.

13. The system of claim 1, wherein the beacon emitter is a micro-beacon.

14. The system of claim 1, wherein the customer's location is a high-rise building.
